(19) United States
(12) Patent Application Publication
(10) Pub. No.: US 2011/0079968 A1
(43) Pub. Date: Apr. 7, 2011

(54) Turf groomer

(76) Inventors: Stephen Murphy, Ile Bizard (CA); John Huard, JR., Barrington, RI (US); Perry DiPiazza, Wyckoff, NJ (US); Daniel J. Sovocool, Sidney-Center, NY (US); Eric W. Hulbert, Walton, NY (US)

(21) Appl. No.: 12/587,289

(22) Filed: Oct. 5, 2009

(51) Int. Cl. B60G 17/00; A01D 7/00

(52) U.S. Cl. 280/6.155; 56/400.21

(57) ABSTRACT

A turf groomer for grooming and maintaining synthetic turf including a base structure, and at least one brush arm, at least one rotating member, and a plurality of rake tines connected to the base structure. The at least one brush arm has a plurality of arm segments and is positioned at a front region of the base structure. The at least one rotating member has one or more prongs extending radially from its center, is positioned along an axis of rotation, and is distally spaced from the at least one brush arm. The plurality of rake tines is distally spaced from the at least one rotating member. The turf groomer may include a second brush arm positioned at a rear region of the base structure, and a static reducing device to inhibit the buildup of static electricity as the turf groomer passes over the turf, and/or an extension brush arm.

### RELATED APPLICATIONS

This patent application claims the filing benefit of U.S. Provisional Patent Application Ser. No. 61/195,009, filed Oct. 3, 2008; the contents of which are incorporated by reference herein.

### FIELD OF THE INVENTION

The present invention relates generally to a machine to groom and maintain a turf; and more particularly to groom and maintain a synthetic turf assembly, which is also capable of mixing and aerating an infill material.

### BACKGROUND OF THE INVENTION

Synthetic turf is a durable, natural turf alternative commonly used in athletic fields, airports, golf courses, and the like. A synthetic turf assembly or system generally includes rows of upstanding ribbons or filaments representing blades of grass attached to or through a pile fabric having a flexible sheet backing. The synthetic turf assembly may also have an infill material interstitially disposed between the upstanding ribbons, such as sand, rubber, or layers and combinations thereof—as is disclosed in the synthetic turf systems disclosed in U.S. Pat. Nos. 6,551,689 and 5,958,527, issued to Jean Prévost. The disposed infill material supports the ribbons in a substantially upright position while also providing the turf assembly a more natural play and feel.

With use, the turf's ribbons may become tangled, flattened, and/or matted down, and the infill material separated out and compacted, which may possibly result in inhibiting proper water drainage and play of the field. Therefore, the turf should be properly maintained by mixing, aerating, and leveling the infill material, and brushing out the ribbons to return them toward their original substantially upright position.

To accomplish some of these tasks, turf groomers have been used and pulled behind a small tractor, e.g., John Deere Turf Gator™, or other equipment capable of towing equipment. Such groomers typically employ a brush which, when dragged over the surface of the synthetic turf assembly, removes debris from the turf's surface and brushes out the ribbons.

Other known types of turf groomers also contain rakes tines, such as those found on a lawn rake and used for removing leaves—the tines acting to smooth over and comb through the synthetic ribbons.

A need still exists however, for a turf groomer that can aerate and maintain the infill material of a synthetic turf system, while also maintaining the ribbons.

Additionally, the grooming of the ribbons and aeration of the infill material may create static electricity that causes the ribbons and infill material to stick together, to each another, and/or to the grooming equipment. As such, a need exists for a turf groomer that can inhibit or minimize static.

Applicant's invention is directed to, among other things, addressing the concerns associated with maintaining an artificial turf system by removing debris from the turf, brushing out the ribbons, and mixing and aerating the infill material while inhibiting the static that may form as a result thereof.

### SUMMARY OF THE INVENTION

Accordingly, this invention is directed toward a turf groomer having at least one brush arm, at least one rotating member; and a plurality of rake tines—all of which are operatively connected to a base structure. The base structure may further include a towing mechanism, and preferably has four wheels located proximate the corners of a rectangular base structure.

To operate the turf groomer, it is hitched to a mobile piece of equipment, such as a Turf Gator™, and transported over the surface of a synthetic turf system. The brush arm, which may be located in a front region of the base structure, acts to brush out the turf's ribbons and remove surface debris. Prongs on the rotating members, preferably located behind the brush arm, act to mix and aerate the infill material and reverse the effects of separation and compaction thereof. A plurality of rake tines, preferably located behind the rotating members, smooth over the infill material and rake through the ribbons.

In one embodiment of the invention, the turf groomer includes a second brush arm located behind the plurality of rake tines proximate a rear region of the base structure. The second brush arm acts to give the turf a final grooming after the turf and infill material have been worked over by the first brush arm, rotating members, and rake tines.

In a preferred embodiment, the brush arm includes two sets of brushes angled toward each another, and each set has a plurality of arm segments forming interconnected “V”s or “U”s. This configuration allows the groomer to more smoothly navigate over a synthetic turf system, and more effectively groom the turf assembly.

The brush arm may include a brush arm height-adjustment mechanism that allows the height of the brush arm above the turf assembly to be adjusted to a desired level based upon various considerations such as, and not limited to, the type of turf, height of the synthetic ribbons, and depth of the infill.

In certain embodiments of the invention, brush arm extension members may be added to either or both end(s) of the brush arm, thereby extending the width of the brush arm. These bar arm extension members are operatively attached to the base structure and are capable of being pivoted upward in an “idle” position.

To aerate and mix the infill material, at least one rotating member having one or more prongs extending in a radial direction from its center is positioned along an axis of rotation. Preferably, the turf groomer has a plurality of rotating members each having multiple prongs, all of which are located proximate a housing or hood, which substantially covers the rotating members and deters the infill material from being sprayed about as the prongs rotate through it. The rotating members may also include a height-adjustment mechanism that allows the height of the rotating members above the turf assembly to be adjusted to an appropriate level by the user in light of the various depths and compositions of infill material.

With respect to the rake tines, certain embodiments include a rake tine height-adjustment mechanism that allows the height of the rake tines above the turf assembly to be altered to a desired height.

In a further embodiment of the invention, the turf groomer also includes a static reducing device that operates to reduce the static generated by the turf groomer and inhibit the effect therefrom on the turf's ribbons, infill, and groomer equipment. In one such embodiment, a water tank located on or attached to the turf groomer can spray water onto the turf assembly and groomer equipment to reduce static. Additionally, devices having anti-static properties may be pulled behind the groomer to contact the ribbons and infill material, which may also serve the same function.

One object of the invention therefore is to provide a turf groomer having at least one rotating member that aerates and mixes infill material, and also grooms the ribbons and removes debris. In addition, a static reducing device may be employed to reduce any static created by the turf groomer that may interfere with the grooming process.

Other objects, advantages, and features of the present invention will become apparent from the following specification taken in conjunction with the accompanying drawings and claims.

### BRIEF DESCRIPTION OF THE DRAWINGS

FIG. 1 is a forward perspective view of a turf groomer in accordance with the present invention;

FIG. 2 is a rearward perspective view of a turf groomer in accordance with the present invention;

FIG. 3 is a top view of a turf groomer in accordance with the present invention;

FIG. 4 is a front view of a turf groomer in accordance with the present invention;

FIG. 5 is a side view of a turf groomer in accordance with the present invention;

FIG. 6 is an exploded view of a turf groomer in accordance with the present invention;

FIG. 7 is a view of one embodiment of the brush arm being shown generally perpendicular to the direction of travel of the turf groomer, wherein two sets of brushes are depicted;

FIG. 8 is a perspective view of one embodiment of the invention utilizing a bar arm extension in a use mode; and,

FIG. 9 is a perspective view of the embodiment of the invention shown in FIG. 7, wherein the bar arm extension is in the non-use mode.

### DETAILED DESCRIPTION OF THE PRESENT INVENTION

While this invention is susceptible to embodiments in many different forms, there are shown in the drawings and will herein be described in detail, preferred embodiments of the invention with the understanding that the present disclosures are to be considered as exemplifications of the principles of the invention and are not intended to limit the broad aspects of the invention to the embodiments illustrated.

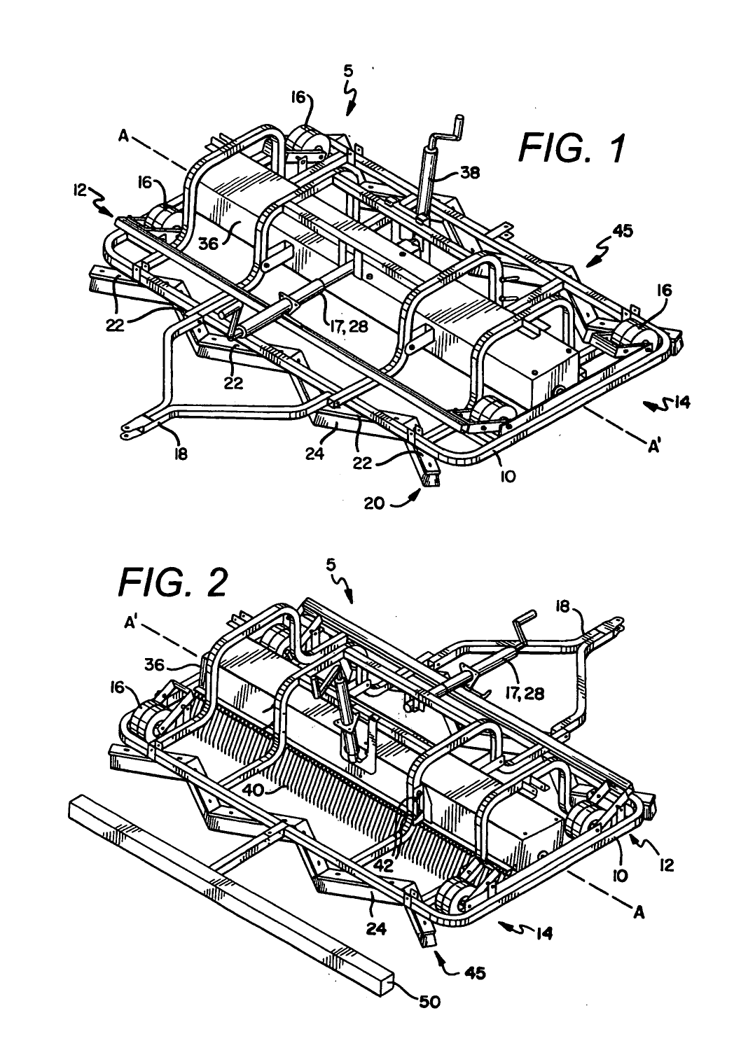

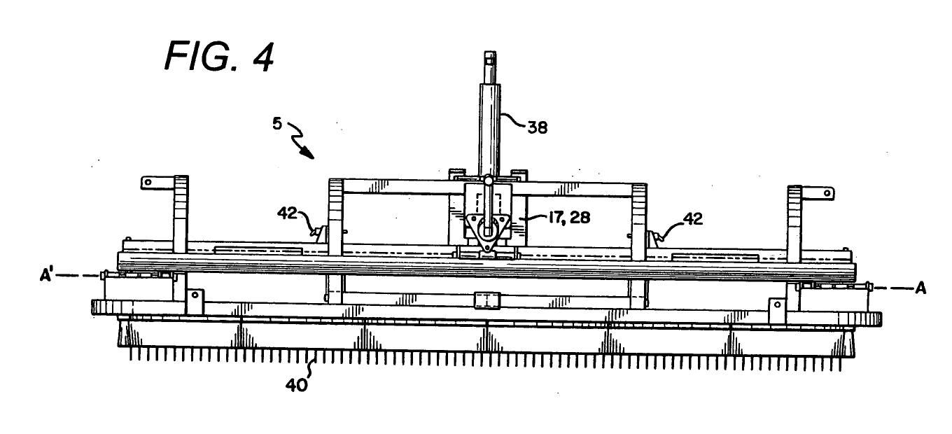

Referring to the drawings, especially FIGS. 1-8, the reference numeral 10 designates generally a turf groomer having a base structure 10, at least one brush arm 20, at least one rotating member 30, and a plurality of rake tines 40.

The base structure 10 onto which the other parts of the turf groomer 5 are mounted or connected is preferably made of metal or other strong, rigid material, and has a front region 12, a rear region 14, and at least one wheel 16. In a preferred embodiment, four rubber treaded wheels 16 are located substantially at the corners of the substantially rectangular base structure 10. A towing mechanism 18, such as a towing hitch or other structure providing towing capabilities, may be operatively connected to the base structure 10, which will allow for the turf groomer 5 to be pulled behind a tractor, e.g., Turf Gator™, or other equipment having towing capabilities. The turf groomer 5 may also be incorporated into a vehicle, such as the Turf Gator™.

The wheels 16 may include a wheel height-adjustment mechanism 17 that facilitates adjustment of the wheels 16 so that base structure 10 sits further away from, or closer, to the ground. The range of the height adjustment can be related, and perhaps limited, to the operable height—e.g., “length”—of the bristles of a brush 24 so as to necessitate the replacement of a worn brush 24 or brush arm segment 22 attached to the brush arm 20. And this height-adjustment may be carried out by simply repositioning the point at which the wheels 16 are attached to the base structure 10. For instance, by loosening, moving, and then re-tightening the wheels to the base structure 10, such as with screws, washers, nuts and bolts, or any such hardware known for similar uses.

A more complex wheel height-adjustment mechanism 17 may also be employed, such as a hand-crank, locking handle, jack, or other such device known to a person having ordinary skill in the art. These height-adjustment mechanisms may work alone or in conjunction with other structural components and interconnections to adjust only the height of the base structure 10, wheels 16, or other parts of turf groomer 5 as well.

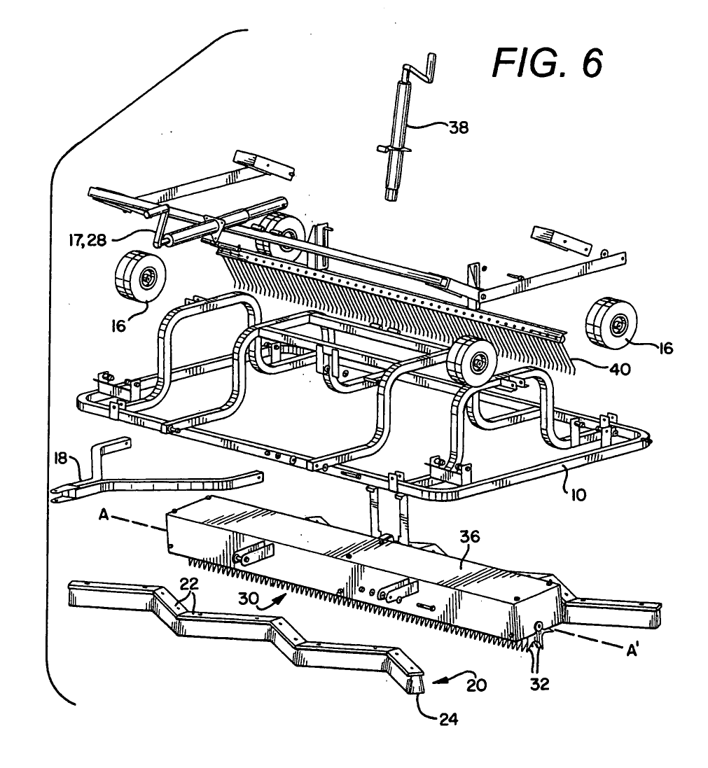

At least one brush arm 20 is attached to the base structure 10. The brush arm 20 may have a plurality of brush arm segments 22 and it may be an integral part of the base structure 10, or mounted thereto. The brush 24 is of a size and thickness capable of clearing debris and grooming a synthetic turf system and is attached to at least one brush arm 20. In certain embodiments, the at least one brush arm 20 includes two sets of brushes (see FIG. 7) attached to the brush arm 20, wherein the bristles of the sets of brushes are angled toward one another to more effectively groom the turf assembly.

In a preferred embodiment, the at least one brush arm 20 is located proximate the front region 12 of the base structure 10 and has a plurality of brush arm segments 22 extending the width of the base structure 10. The brush arm segments 22 may form an interconnected, continuous “V,” “W,” or “M” shape, with adjacent brush arm segments 22 forming obtuse, acute, or right angles with respect to one another. Such configurations of the brush arm 20 have been observed to reduce the “bouncing” and “jumping” of the turf groomer 5 during operation because the “wave-like” shape of the brush arm 20 shears its way through the synthetic fibers of the turf assembly, which allows for the turf groomer to travel in a more steady, level gait, which further allows for the rotating member 30 and tines 40 to have a greater effect on the turf assembly's synthetic ribbons and infill material.

The brush arm 20 and its brush arm segments 22 however may be configured in other formations that are capable of carrying out this aspect of the invention; such as, and not limited to, adjacent brush arm segments 22 being at right angles or acute angles with respect to one another. The brush arm 20 and associated brush arm segments 22 may even be curvilinear or wave-like and form an interconnected “U” shape. Moreover, a single unitary brush 24 may run the entire width of the brush arm 20, or multiple, individual brushes 24 may be mounted to brush arm segments 22 of the brush arm 20.

The brush arm 20 may also include a brush arm height-adjusting mechanism 28 of similar type to that of the wheel height-adjusting mechanism 17, and may similarly adjust only the height of brush arm 20, or also other parts of the turf groomer 5 such as the wheels 16, rotary members 30, rake tines 40, base structure 10, or any combination thereof. The same can be said for any of the height-adjustment mechanisms 17, 38, 42 disclosed herein.

As shown in FIGS. 1-3, the turf groomer 5 may further include a second brush arm 45 operatively attached to and proximate the rear region 14 of the base structure 10, wherein the second brush arm 45 includes any of the aforementioned properties of the at least one brush arm 20.

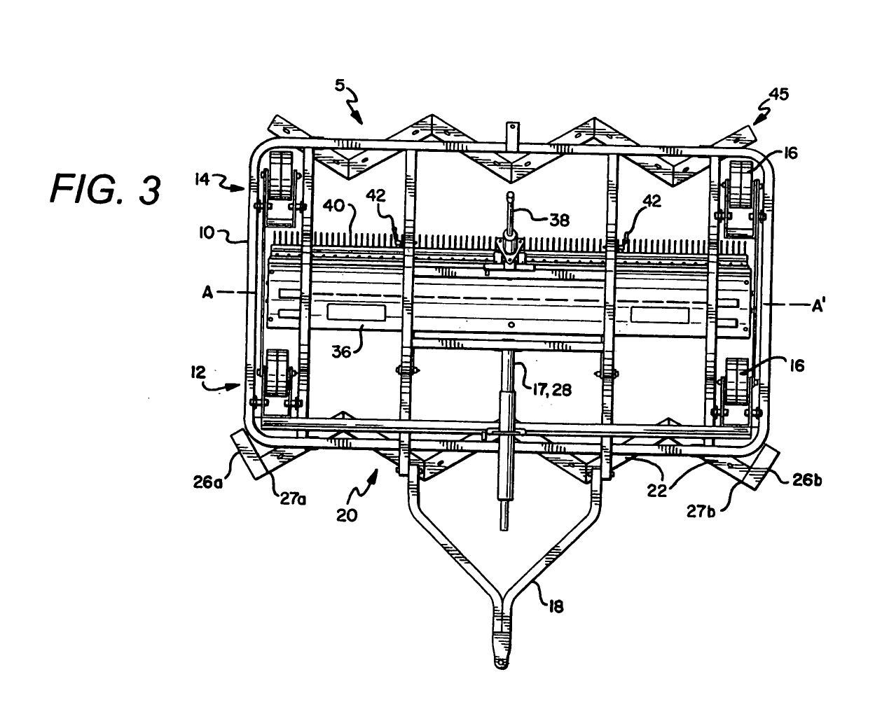

The width of the brush arm 20 may be extended by a brush arm extension member 26, as shown in FIG. 3. The brush arm 20 includes a first end 27a and a second end 27b, and a first brush extension member 26a is attached to the first end 27a of the brush arm 20 and a second brush extension member 26b is attached to the second end 27b of the brush arm 20.

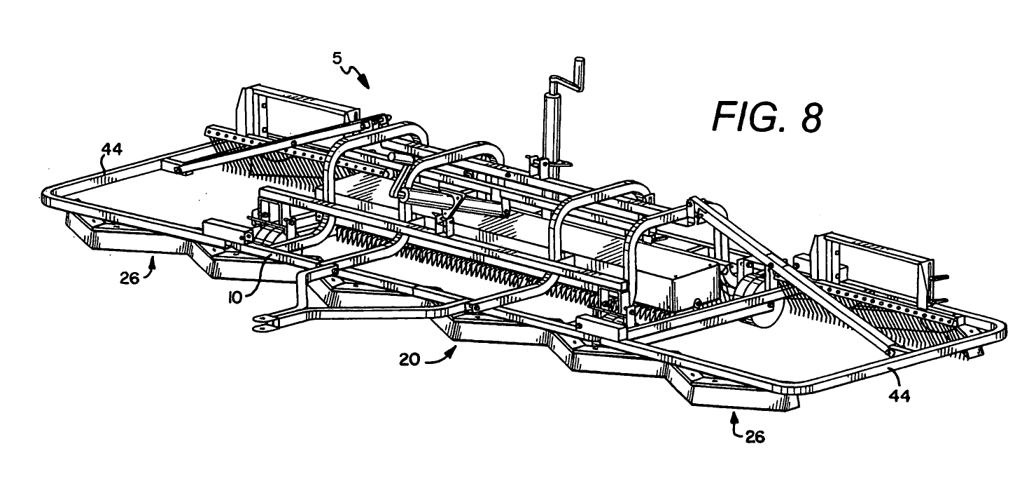

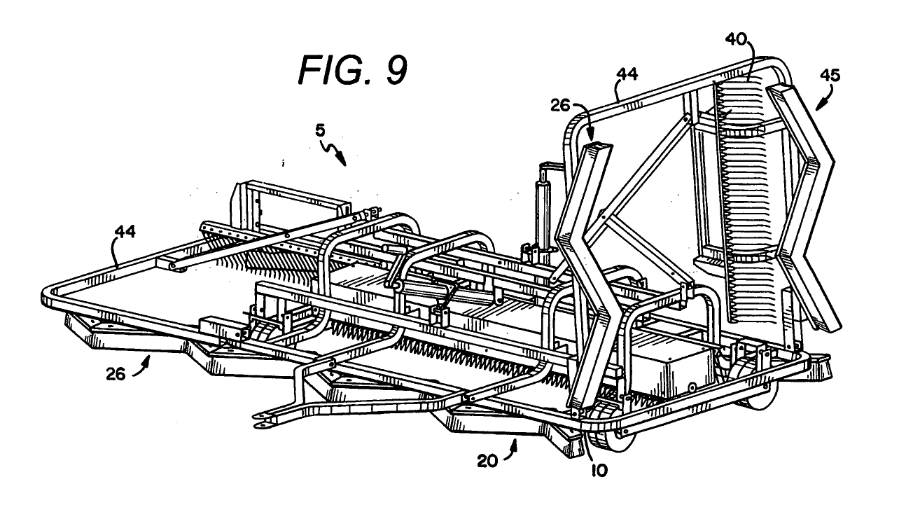

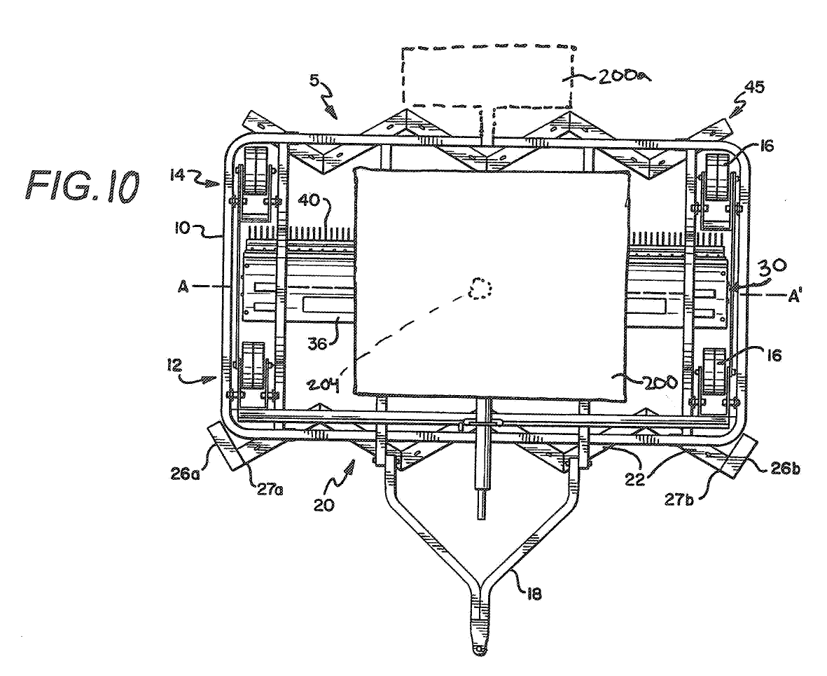

In an alternative embodiment of the brush arm extension member 26, the brush arm extension member is attached to an auxiliary structure 44, which essentially extends the width of the base structure 10. Preferably, the base structure 10 has a width of approximately seven feet, and the width of the auxiliary structure 44 is approximately four feet. FIGS. 8 and 9 depict the auxiliary structure 44 operatively attached to the base structure 10. The auxiliary structure 44 is positioned proximate the base structure 10 such that the brush arm extension member 26 essentially extends the effective length brush arm 20. The auxiliary structure 44 can be operatively attached to the base structure 10 so that the auxiliary structure 44 can be raised and lowered between a use (see FIG. 8) and a non-use (see FIG. 9) position. Attachment of the base structure 10 and auxiliary 44 structure(s) can be attained by any means known to a person having ordinary skill in the art, such as, and not limited to: pivots, hinges, couplings, and sockets. Additionally, features of the turf groomer 5—such as the plurality of tines 40 and the rotating member(s) 30—may also be incorporated into the auxiliary structure 44. Likewise, the various height adjustment mechanisms similar to those disclosed herein may individually be incorporated into the auxiliary structure 44, or such height adjustment mechanisms may be combined and connected with the corresponding adjustment mechanism of the base structure 10.

A second auxiliary structure 44 can be operatively attached to the opposite end of the base structure 10 to further increase the overall width of the turf groomer 5 to about fifteen feet. In such a configuration, each auxiliary structure 44 can be independently positioned in the use or non-use position. That is, each of the auxiliary structures 44 can individually be placed in a raised (non-use) or lowered (use) position.

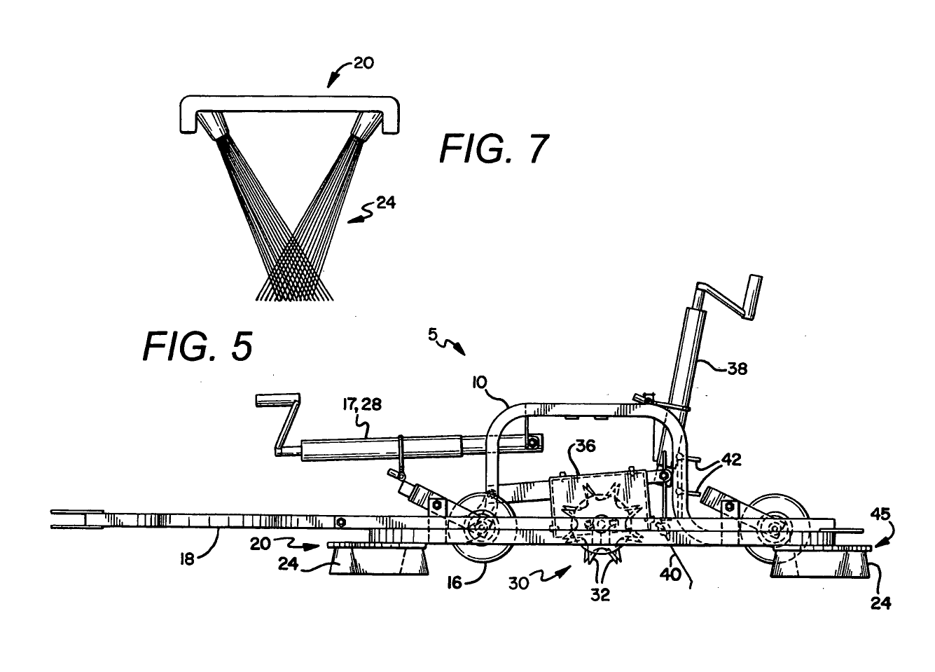

The turf groomer 5 may further include at least one rotating member 30 positioned along an axis of rotation A-A′ and having one or more prongs 32 extending radially outward from its center. Referring now to FIGS. 5-6, several rotating members 30, each including several prongs 32, are at least partially contained or covered within a housing 36 and attached across the base structure 10 between the at least one brush arm 20 proximate the front region 12 of the base structure 10 and the plurality of rake tines 40. In other embodiments, the at least one rotating member 30, as well as the housing 36, are detachable—thus providing access for cleaning and maintenance of the rotating members 30, as well as use of the turf groomer 5 without the rotating members 30, if so desired.

The composition of the rotating members 30 and prongs 32 extending there from preferably includes a rigid material such as metal, hard plastic, or other material capable of mixing a compacted infill material; and can be configured as such to be capable of reaching into the turf assembly and aerating the infill material as the turf groomer 5 travels over it. To facilitate this operation, the at least one rotating member 30 may include a rotating member height-adjustment mechanism 38 of the kind similar to that as disclosed herein with respect to the wheel height-adjusting mechanism 17 and the brush arm height-adjusting mechanism 28.

The turf groomer 5 may further include the plurality of rake tines 40 being comprised of semi-rigid finger members, such as those commonly found on a lawn rake, which groom the synthetic turf ribbons and smooth and even the aerated infill material. The plurality of rake tines 40 are preferably made of metal, plastic, or other material capable of carrying out this process. In one aspect of the invention, the plurality of rake tines 40 can be positioned behind and proximate the at least one rotating member 30.

As shown in FIG. 2, the plurality of rake tines 40 may also include a tine height-adjustment mechanism 42, such as a hand-crank, locking handle, jack, or other such device known to one skilled in the art; which may control only the height of the tines 40, or the height of other aspects of turf groomer 5, as disclosed herein.

In a further embodiment of the invention, the turf groomer 5 includes a static reducing device 50 as shown in FIG. 2. Due to the nature of certain infill materials, static electricity may form as the turf groomer 5 operates on the synthetic turf assembly, thereby causing the turf assembly's ribbons and infill material to become electrically charged and subsequently attach to one another or parts of the turf groomer 5—such as the brush arm 20, rotating member 30, rake tines 40, or base 10 and auxiliary 44 structures.

To mitigate the effects of the static charge, a static reducing device 50 may be employed, such as a water tank that sprays water onto the ribbons, infill material, and/or parts of the turf groomer 5. The static reducing device 50 may be placed at various positions on the turf groomer 5, such as proximate the center of mass of the turf groomer or proximate the at least one rotating member 30. Additionally, what is known in the art as a “drag behind” static reducer may be used, which is towed or pulled behind the turf groomer 5. The drag behind device may be a water tank, but is preferably a device that directly contacts the turf assembly, e.g., ribbons, infill material; to reduce static.

It is to be understood that the invention contemplates incorporating other static reducing devices and liquids to inhibit or reduce the effects of static as would be known to a person having ordinary skill in the art.

While in the foregoing there has been set forth a preferred embodiment of the invention, it is to be understood that the present invention may be embodied in other specific forms without departing from the spirit or central characteristics thereof. The present embodiments, therefore, are to be considered in all respects as illustrative and not restrictive, and the invention is not to be limited to the details given herein. While specific embodiments have been illustrated and described, numerous modifications come to mind without significantly departing from the characteristics of the invention and the scope of protection is only limited by the scope of the accompanying claims.

1. A turf groomer comprising:
a base structure;
at least one brush arm operatively connected to the base structure wherein the brush arm includes a plurality of arm segments;
at least one rotating member operatively connected to the base structure and distally spaced from the at least one brush arm, the at least one rotating member including one or more prongs extending radially from its center and positioned along an axis of rotation; and
a plurality of rake tines operatively connected to the base structure,
wherein the base structure has a front region and a rear region, and the at least one brush arm being located proximate the front region and,
wherein the at least one rotating member is located between the at least one brush arm and the plurality of rake tines.

2. The turf groomer according to claim 1 wherein adjacent arm segments of the at least one brush arm are located with respect to one another at angles selected from the group consisting of right angles, obtuse angles, and acute angles.

3. The turf groomer according to claim 1 wherein the at least one brush arm is curvilinear.

4. The turf groomer according to claim 1 wherein the at least one brush arm includes two sets of brushes.

5. The turf groomer according to claim 4 wherein the two sets of brushes are angled toward one another.

6. The turf groomer according to claim 1 wherein the at least one brush arm includes a brush arm height-adjustment mechanism.

7. The turf groomer according to claim 1 comprising at least one brush extension member operatively connected to the at least one brush arm.

8. The turf groomer according to claim 7 comprising two brush extension members, wherein the at least one brush arm comprises a first end and a second end, and one of the two brush extension members is attached to the first end of the of the at least one brush arm, and the other brush extension member is attached to the second end.

9. (canceled)

10. The turf groomer according to claim 1 further including a second brush arm.

11. The turf groomer according to claim 10 wherein the base structure has a front region and a rear region, and the second brush arm being located proximate the rear region.

12. The turf groomer according to claim 1 comprising at least one wheel operatively connected to the base structure.

13. The turf groomer according to claim 12 wherein the at least one wheel includes a wheel height-adjustment mechanism.

14. The turf groomer according to claim 1 wherein the at least one rotating member includes a rotating member height-adjustment mechanism.

15. The turf groomer according to claim 1 wherein the at least one rotating member is removable.

16. The turf groomer according to claim 1 further comprising a housing for the at least one rotating member.

17. (canceled)

18. The turf groomer according to claim 1 wherein the plurality of rake tines include a tine height-adjustment mechanism.

19. The turf groomer according to claim 1 comprising a towing mechanism operatively connected to the base structure.

20. The turf groomer according to claim 1 comprising a static reducing device.

21. The turf groomer according to claim 20 wherein the static reducing device is a water tank.

22. The turf groomer according to claim 21 wherein the turf groomer has a center of mass and the location of the water tank is selected from the group consisting of proximate the center of mass of the groomer, proximate the at least one rotating member, and behind and operatively connected to the base structure.

23. The turf groomer according to claim 1, further comprising an auxiliary structure operatively attached to the base structure, the auxiliary structure including a brush arm extension member, and the auxiliary structure being movably connected to the base structure such that the auxiliary structure is capable of being positioned in a use and non-use position, wherein in the use position, the brush arm extension member is substantially aligned with the brush arm.

24. A turf groomer comprising:
a base structure;
at least one brush arm operatively connected to the base structure wherein the brush arm includes a plurality of arm segments;
at least one rotating member operatively connected to the base structure and distally spaced from the at least one brush arm, the at least one rotating member including one or more prongs extending radially from its center and positioned along an axis of rotation; and
a plurality of rake tines operatively connected to the base structure,
wherein the base structure has a front region and a rear region, and the at least one brush arm being located proximate the front region and,
wherein at least two adjacent arm segments of the at least one brush arm form an angle with respect to each other.

25. A turf groomer comprising:
a base structure;
at least one brush arm operatively connected to the base structure wherein the brush arm includes a plurality of arm segments;
at least one rotating member operatively connected to the base structure and distally spaced from the at least one brush arm, the at least one rotating member including one or more prongs extending radially from its center and positioned along an axis of rotation; and
a plurality of rake tines operatively connected to the base structure,
wherein the base structure has a front region and a rear region, and the at least one brush arm being located proximate the front region and,
wherein at least two adjacent arm segments of the at least one brush arm form a curvilinear shape.
